(19) United States
(12) Patent Application Publication
(10) Pub. No.: US 2008/0131856 A1
(43) Pub. Date: Jun. 5, 2008

(54) Capturing apparatus with a star observing function and a star observing method

(76) Inventor: Yu-Shuang Chi, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/701,463

(22) Filed: Feb. 2, 2007

(30) Foreign Application Priority Data
Dec. 4, 2006 (TW) 95144969

(51) Int. Cl. G09B 27/00

(52) U.S. Cl. 434/284

(57) ABSTRACT

A capturing apparatus with a star observing function and a star observing method is disclosed. The user obtains a constellation photo from the constellation database by using the satellite time and the longitude and the latitude information at which the user is using the capturing apparatus for observing the stars. The user can find the target constellation by utilizing the azimuth guidance provided from the azimuth guiding unit and capture the target constellation.

### BACKGROUND OF THE INVENTION

1. Field of the Invention

The present invention relates to a capturing apparatus. In particular, this invention relates to a capturing apparatus with a star observing function and a star observing method.

2. Description of the Related Art

Previously people used their eyes to observe the stars in the sky and used a constellation map to find a constellation. However, it is complex for a beginner and they will often become frustrated and disenchanted, leading the person to lose his or her interest in observing the stars.

And when the observer is in the countryside and the sky is full of stars, the observer cannot clearly differentiate the constellations from one another and cannot find stars without a constellation map.

In order to overcome this problem, U.S. Pat. No. 4,938,697 discloses a multi-dimensional astral position finding device. The multi-dimensional astral position finding device cooperates with a still camera to take a picture of the target constellation. Therefore, the user can find the target constellation in the sky. However, the operating method is difficult and still complex.

### SUMMARY OF THE INVENTION

One particular aspect of the present invention is to provide a capturing apparatus with a star observing function and a star observing method. The present invention obtains a constellation photo from a constellation database referring to the satellite time and the longitude and latitude information while the user uses the capturing device. Therefore, the user refers to the azimuth guidance provided from the azimuth guiding unit to observe the target constellation and capture the target constellation.

The capturing apparatus with a star observing function includes an image capturing unit, an image processing unit, an image displaying unit, an internal memory unit, an external memory control unit, a global position system, an operation processing unit, an azimuth guiding unit, a button control unit, a constellation database, and an external memory.

In one embodiment, the user inputs a control command to the operation processing unit to make the image displaying unit display the functions menu, in which the user can select an item to observe stars.

When the capturing apparatus executes the selected item, the image displaying unit displays the orientation constellation list and the constellation photo referring to the location and time at which the user is using the capturing apparatus. The user selects one orientation constellation from the orientation constellation list to find the orientation constellation according to the azimuth guidance provided from the azimuth guiding unit and the constellation photo.

After the user finds the orientation constellation, the user selects a target constellation from the orientation constellation list that corresponds to the location and time at which the user is using the capturing apparatus. Next, the user finds and captures the target constellation according to the azimuth guidance provided from the azimuth guiding unit and the constellation photo.

In another embodiment, the user inputs a control command to the operation processing unit to make the image displaying unit display the functions menu, and the user can select an item to observe stars.

When the capturing apparatus executes the selected item, the image displaying unit first displays the orientation constellation list and the constellation photo that corresponds to the location and time at which the user is using the capturing apparatus. The user selects one orientation constellation from the orientation constellation list.

Next, the operation processing unit determines whether the selected orientation constellation is observable in the current sky area or not. Next, the user finds the orientation constellation according to the azimuth guidance provided from the azimuth guiding unit and the constellation photo.

Finally, after the user finds the orientation constellation, the user selects one target constellation from the orientation constellation list. The operation processing unit determines whether the selected target constellation is observable in the current sky area or not, and then the user can find the target constellation according to the azimuth guidance provided from the azimuth guiding unit and the constellation photo.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1A is a block diagram of the capturing apparatus with a star observing function of the first embodiment of the present invention;

FIG. 1B is a block diagram of the capturing apparatus with a star observing function of the second embodiment of the present invention;

FIG. 2 is a flow chart of the star observing method utilizing the capturing apparatus with a star observing function of the present invention;

FIG. 3A is a schematic diagram of the orientation constellation list and the constellation photo displayed on the image displaying unit;

FIG. 3B is a schematic diagram of a mark showing the location of the selected orientation constellation located on the orientation photo;

FIG. 4A is a schematic diagram of the target constellation list and the constellation photo displayed on the image displaying unit;

FIG. 4B is a schematic diagram of a mark showing the location of the selected target constellation located on the orientation photo;

FIG. 5 is a schematic diagram of the user using the capturing apparatus to capture the target constellation; and

FIG. 6 is another flow chart of the star observing method utilizing the capturing apparatus with a star observing function of the present invention.

### DETAILED DESCRIPTION OF THE PREFERRED EMBODIMENTS

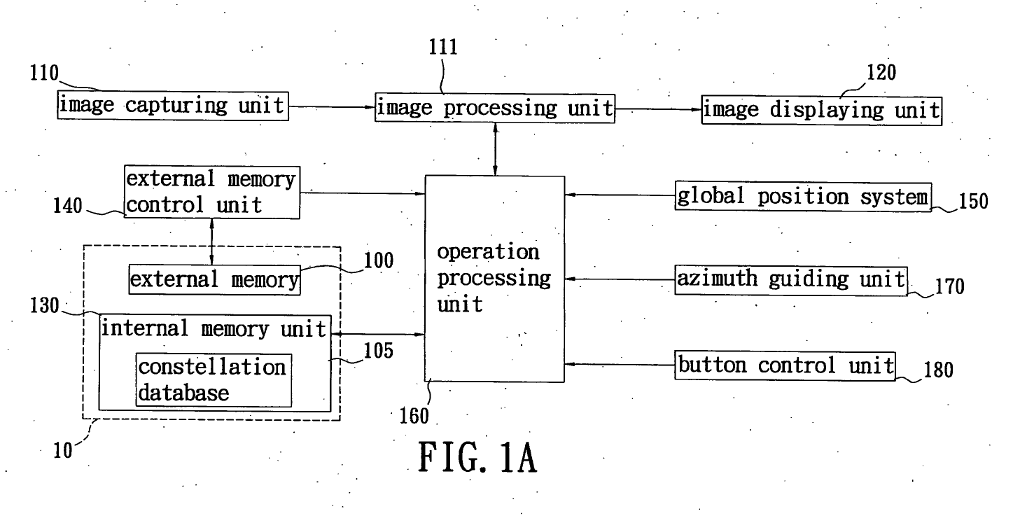

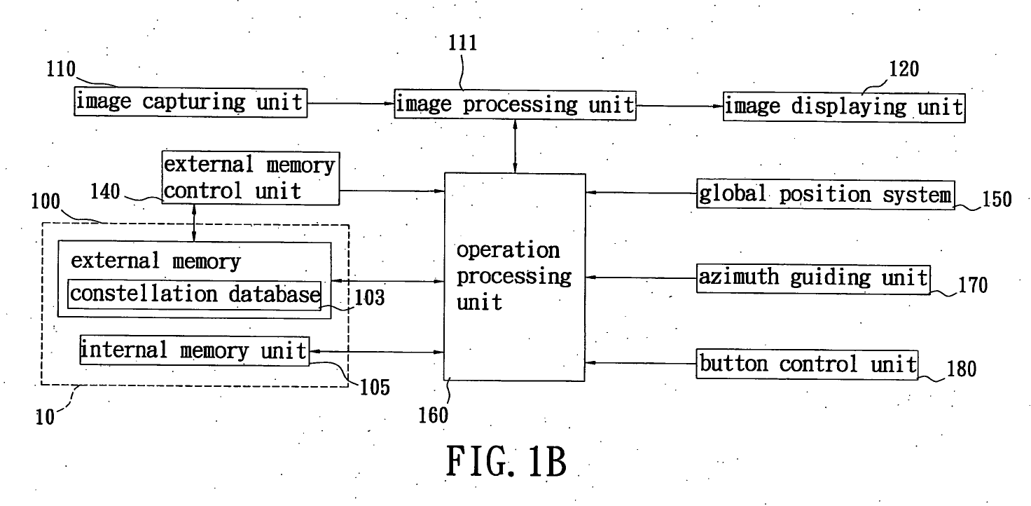

Reference is made to FIG. 1A, which shows a block diagram of the capturing apparatus with a star observing function of the first embodiment of the present invention. The capturing apparatus includes an image capturing unit 110, an image processing unit 111, an image displaying unit 120, an external memory control unit 140, a global position system 150, an operation processing unit 160, an azimuth guiding unit 170, a button control unit 180, and a storing unit 10.

The storing unit 10 includes an external memory 100, and an internal memory unit 105. The internal memory unit 105 includes a constellation database 103.

When the capturing apparatus is turned on, the operation processing unit 160 executes control of internal components. The operation processing unit 160 makes the external memory control unit 140 detect whether the external memory 20 is placed into the capturing apparatus or not.

When the user wants to capture the image source by using the capturing apparatus, the user must put the external memory 20 into the capturing apparatus in advance. Next, the user uses the button control unit 180 to output an image-capturing control command to the operation processing unit 160. The operation processing unit 160 controls the image capturing unit 110 to capture the desired image source according to the image-capturing control command. The captured image is processed by the image processing unit 111 to form an image file.

After the image file is processed by the operation processing unit 160, the image file is transmitted to the external memory 20 via the external memory control unit 140 and is stored. When the operation processing unit 160 processes the image file, the produced processing data is stored in the internal memory unit 130. According to the settings set by the user, the image file can also be displayed on the image displaying unit 120.

Because the capturing apparatus includes the global position system 150, the longitude and latitude information and the satellite time of the location at which the user is using the capturing apparatus are automatically downloaded when the capturing apparatus is turned on. The longitude and latitude information and the satellite time are processed by the operation processing unit 160 and are stored in the internal memory unit 130.

A plurality of constellation photos is stored in the constellation database 10 in advance. Each constellation photo corresponds to a specific longitude and latitude information and the satellite time and at least one constellation. For example, if the user uses the capturing apparatus in Taipei, at 9 p.m. Oct., 15, 2006 in satellite time, the corresponding longitude and latitude information is north latitude 23 degrees and east longitude 120 degrees. This longitude and latitude information and the satellite time correspond to a corresponding constellation photo in the constellation database 10. This means the sky area can be observed by the user at this time. The accuracy between the constellation photo and the longitude and latitude information and the satellite time can be determined in advance according to the user's requirements.

Alternatively, the azimuth guiding unit 170 in the capturing apparatus provides an azimuth guidance according to the target constellation, the focusing direction, or the constellation photo and the location of the capturing apparatus (the longitude and latitude information provided from the global position system 150). Therefore, the user can change the focusing direction of the capturing apparatus according to the azimuth guidance to find the target constellation. The azimuth guiding unit 170 can be located on the surface of the capturing apparatus, embedded in the capturing apparatus, or added as an auxiliary tool that is not installed in the capturing apparatus. The azimuth guiding unit 170 is a compass, or hardware or software equipment having a compass function.

Therefore, when the user uses the capturing apparatus with a star observing function to observe the constellation, the user utilizes the global position system 150 and the azimuth guiding unit 170 to find the focusing direction of the capturing apparatus, and compares with the constellation photo displayed on the image displaying unit 120 to find the target constellation. If the user wants to observe the stars or take a picture of the constellation in more detail, a telephoto lens can be used.

Reference is made to FIG. 1B, which shows a block diagram of the capturing apparatus with a star observing function of the second embodiment of the present invention. The difference between the second embodiment and the first embodiment is that the constellation database 10 of the first embodiment is embedded in the capturing apparatus and the internal memory unit 130 while the constellation database 10 of the second embodiment is located in the external memory 20.

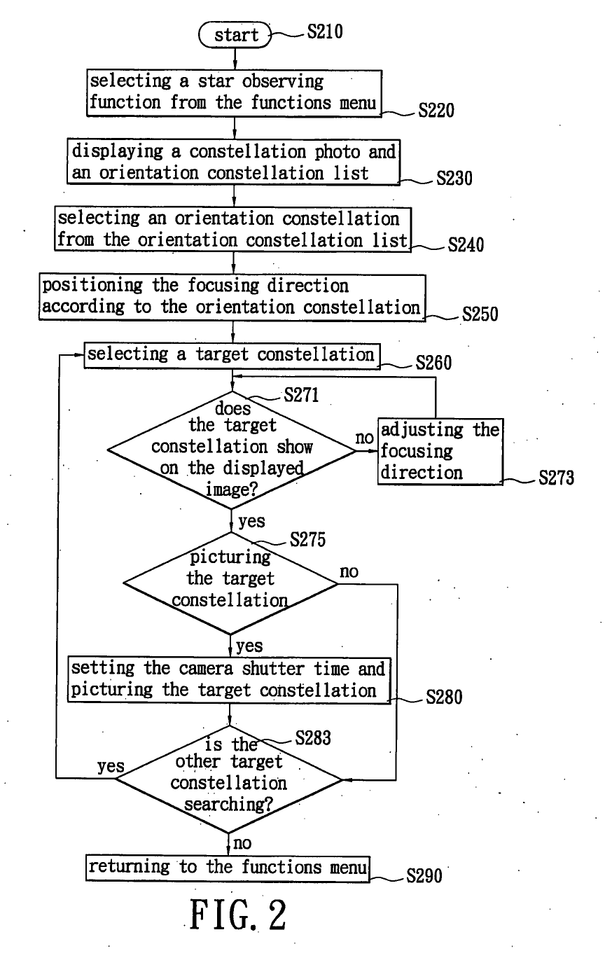

Reference is made to FIG. 2, which shows a flow chart of the star observing method utilizing the capturing apparatus with a star observing function of the present invention.

First, the capturing apparatus is turned on to make the operation processing unit 160 execute control of internal components. When the capturing apparatus is turned on, the global position system 150 automatically downloads the longitude and latitude information and the satellite time of the location at which the user is using the capturing apparatus. The longitude and latitude information and the satellite time are processed by the operation processing unit 160 and are stored in the internal memory unit 130, S210.

When the user wants to observe a constellation by using the capturing apparatus, the user uses the button control unit 180 to output a control command to the operation processing unit 160 so that the operation processing unit 160 starts the application program stored in the internal memory unit 130 to drive the image displaying unit 120 to display a functions menu according to the application program. Next, the user selects a star-observing item from the functions menu displayed on the image displaying unit 120 via the button control unit 180, S220.

Alternatively, the image displaying unit 120 of the capturing apparatus can be a touch panel, and the user can execute the item by directly touching the image displaying unit 120.

When the user selects the star observing function, the operation processing unit 160 executes an application program to make the image displaying unit 120 display an orientation constellation list and a constellation photo, S230. The displayed constellation photo is obtained from the constellation database 10 by the operation processing unit 160 according to the longitude and latitude information and the satellite time downloaded from the global position system 150. Therefore, the obtained constellation photo corresponds to the current sky area that can be observed by the user. The orientation constellation list includes at least one orientation constellation.

For example, in the Northern Hemisphere, the orientation constellations are Polaris, the Summer Big Triangle (composed of Altair, Vega and Deneb), the Big Dipper, Cassiopeia, Pegasus, and the Winter Big Ellipse, etc.

The user then selects an orientation constellation from the orientation constellation menu of the orientation constellation list displayed on the image displaying unit 120, S240. At this time, the user finds the direction represented by the orientation constellation according to the azimuth guidance provided from the azimuth guiding unit 170. An enlarging or a flashing sign is marked on the location of the selected orientation constellation located on the constellation photo. Therefore, the user uses the constellation photo displayed on the image displaying unit 120 to compare with stars in the sky and change the focusing direction of the capturing apparatus to find the orientation constellation, S250. The prerequisite is that the stars in the sky area displayed on the image displaying unit 120 must overlap the constellation photo.

After the user finds the orientation constellation (this means that the orientation constellation is being displayed on the image displaying unit 120), the user can further find the target constellation via the button control unit 180 or the control method of directly clicking the displayed image. In other words, the operation processing unit 160 executes an application program according to the user's control command to make the image displaying unit 120 display a target constellation list. Thereby, the user can select a target constellation from the plurality of target constellations of the target constellation list, S260.

After a specific mark is displayed on the location of the constellation photo corresponded to the selected target constellation, the user can determine whether the sky area displayed on the image displaying unit 120 is the same as the constellation photo with the specific mark or not, meaning determining whether the target constellation is on the displayed image or not, S271.

If the target constellation is not on the displayed image, the user can adjust the focusing direction of the capturing apparatus according to the azimuth guide provided from the azimuth guiding unit 170 and the constellation location on the constellation photo, or via the orientation constellation until the target constellation is found, S273.

Finally, when the user finds the target constellation (this means that the target constellation is displayed on the image captured by the capturing apparatus), the user can determine whether to capture the sky area displayed on the capturing image or not according to their desire, S275. When the user wants to capture the target constellation, the user adjusts the shutter time of the capturing apparatus and other settings, such as focus distance, to capture the target constellation, S280. After the target constellation is captured, the user determines whether to continue to find another target constellation or not, S283.

When the user does not want to search for another target constellation, the method returns to the functions menu to escape from the star observing item or execute another functional item, S290. When the user continues to search for other target constellations, S260 is repeated.

According to the star observing method described above, when the capturing apparatus provides the orientation constellation list and the target constellation list to the user, the capturing apparatus provides the corresponding orientation constellation list and target constellation list which provide the satellite time and the longitude and latitude information at which the user is using the capturing apparatus. For example, when the user uses the capturing apparatus in Taipei, at 9 p.m. Oct., 15, 2006 in satellite time, the capturing apparatus provides the target constellations that can be observed by the user as an option, and the orientation constellation that can be observed by the user as an option, such as the Summer Big Triangle, or Polaris, etc.

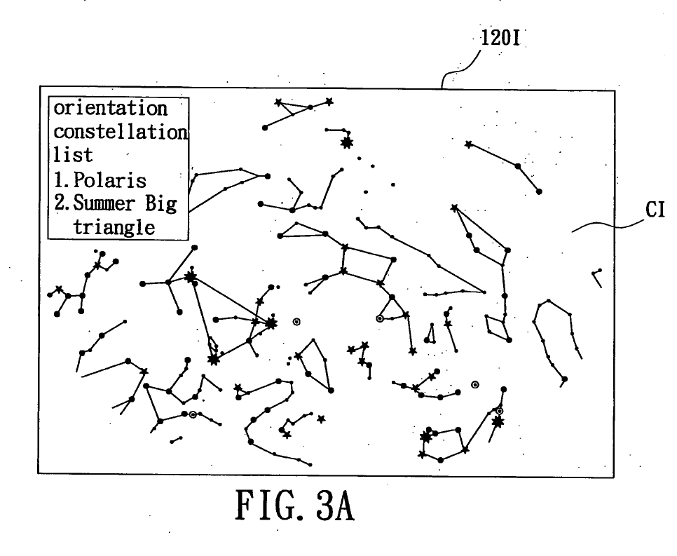

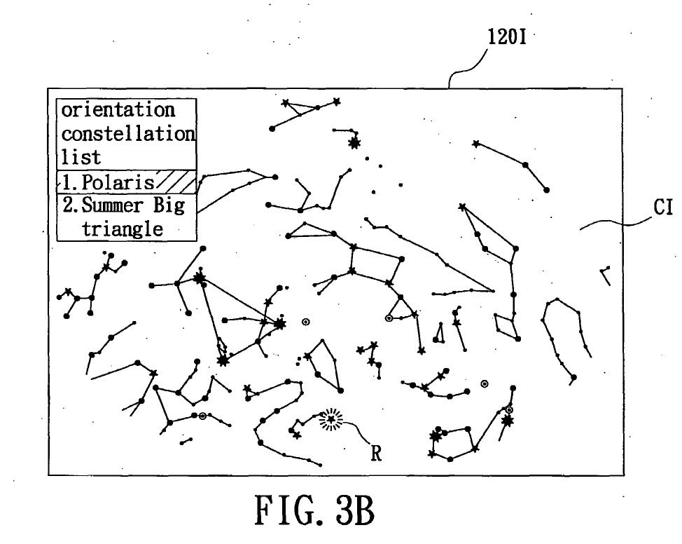

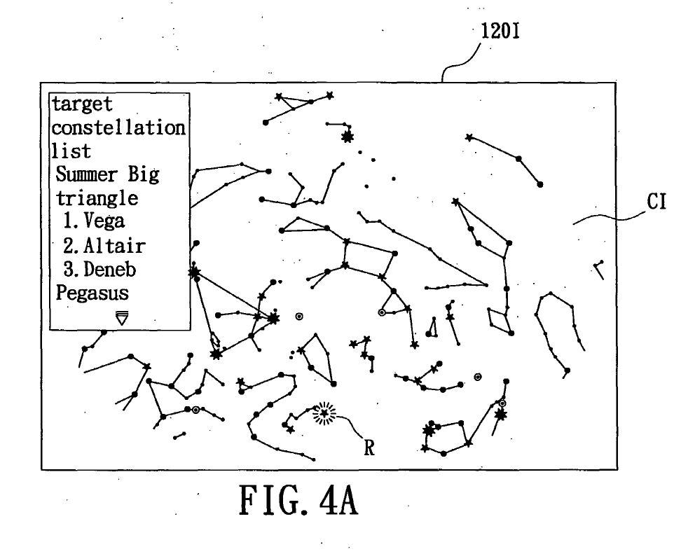

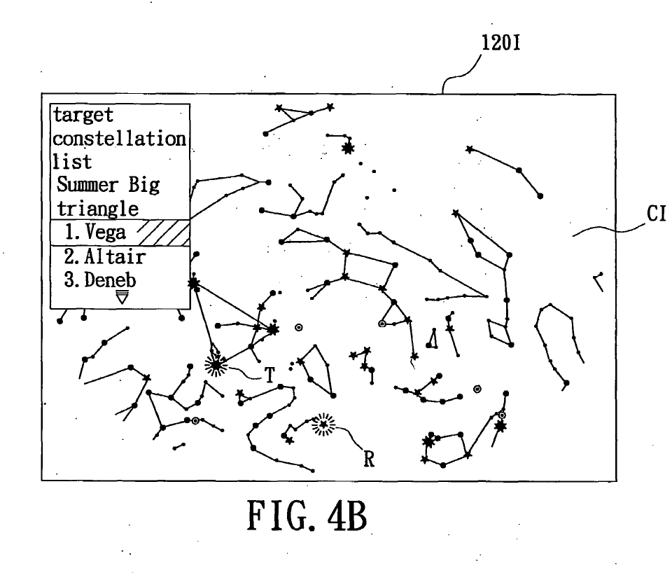

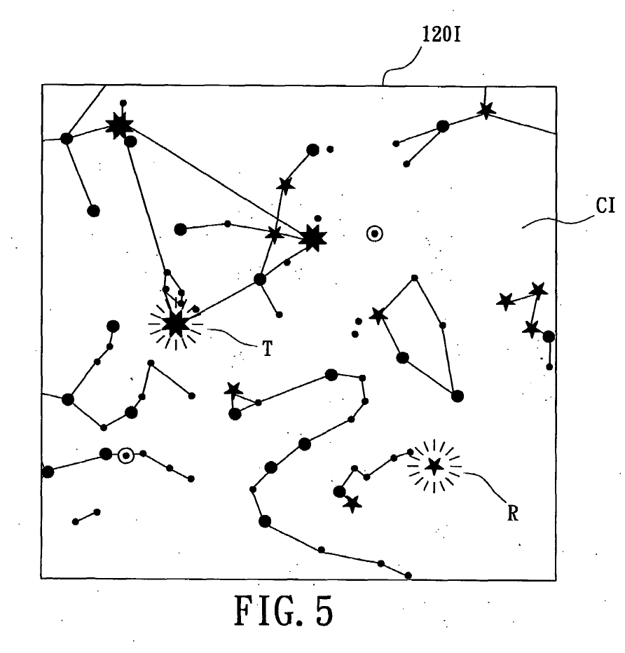

Reference is made to FIGS. 3A and 3B, which show a schematic diagram of the orientation constellation list and the constellation photo displayed on the image displaying unit 120, and a schematic diagram of a mark showing the location of the selected orientation constellation located on the orientation photo. FIGS. 4A and 4B show a schematic diagram of the target constellation list and the constellation photo displayed on the image displaying unit 120, and a schematic diagram of a mark showing on the location of the selected target constellation located on the orientation photo. FIG. 5 shows a schematic diagram of the user using the capturing apparatus to capture the target constellation.

In the above figures, 120I is a displayed image displayed on the image displaying unit 120. CI is a constellation photo obtained from the constellation database 10 according to the current satellite time and the longitude and latitude information. This means the sky area can be observed by the user. R is the orientation constellation that is selected by the user from the orientation constellation list and is marked on the constellation photo. T is the target constellation that is selected by the user from the target constellation list and is marked on the constellation photo.

In the embodiment shown in FIGS. 3A˜4B, although the image displaying unit 120 only displays the constellation photo CI, the orientation constellation list, the target constellation list, the orientation constellation R, and the target constellation T, the present invention is not limited to these items alone. All labels that have been mentioned above or their functions that can be implemented by the application program in the internal memory unit 130 and can be displayed on the displayed image 120I, for example, the metadata corresponding to the capturing location, the azimuth guidance provided from the azimuth guiding unit, etc., are within the scope of the present invention.

The azimuth guidance provided from the azimuth guiding unit 170 that can be installed in the capturing apparatus or on a surface of the capturing apparatus. Alternatively, it can also be externally connected with the capturing apparatus and converted into a label by the application program and displayed on the displayed image 120I. The label that is used to guide the user is within the scope of the present invention, such as text, symbols, figures, etc.

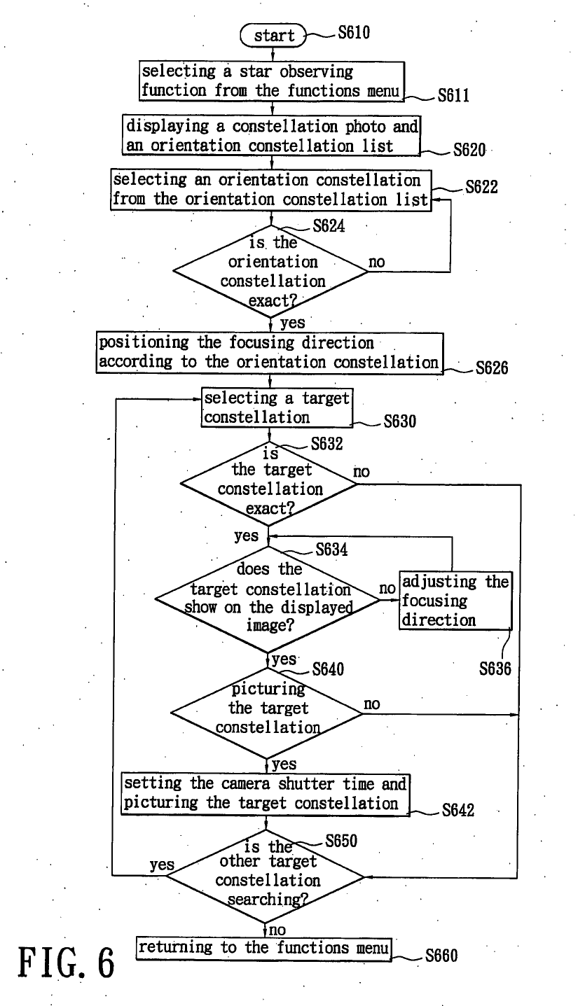

The present invention also provides another star observing method utilizing the capturing apparatus with a star observing function. FIG. 6 shows a flow chart of the star observing method utilizing the capturing apparatus with a star observing function of the present invention.

First, the capturing apparatus is turned on to make the operation processing unit 160 execute control of internal components. When the capturing apparatus is turned on, the global position system 150 automatically downloads the longitude and latitude information and the satellite time of the location at which the user is using the capturing apparatus. The longitude and latitude information and the satellite time are processed by the operation processing unit 160 and are stored in the internal memory unit 130, S610.

When the user wants to observe a constellation by using the capturing apparatus, the user uses the button control unit 180 to output a control command to the operation processing unit 160 so that the operation processing unit 160 starts the application program stored in the internal memory unit 130 to drive the image displaying unit 120 to display a functions menu according to the application program. Then, the user selects a star-observing function from the functions menu displayed on the image displaying unit 120 via the button control unit 180, S611.

When the user selects the star observing function, the operation processing unit 160 executes the application program to make the image displaying unit 120 display an orientation constellation list and a constellation photo, S620.

The user further selects an orientation constellation from the orientation constellation menu of the orientation constellation list displayed on the image displaying unit 120, S622. At this time, the operation processing unit 160 determines whether the orientation constellation selected by the user is exact or not according to the longitude and latitude information and the satellite time (meaning that the orientation constellation can be observed in the sky), S624.

If the selected orientation constellation cannot be observed in the current sky area, the capturing apparatus requests the user to select another orientation constellation. When the selected orientation constellation can be observed in the current sky area, the user adjusts the focusing direction of the capturing apparatus according to the azimuth guidance provided from the azimuth guiding unit 170 for finding the direction represented by the orientation constellation, S626

After the user finds the orientation constellation (meaning that the orientation constellation is displayed on the displayed image of the image displaying unit 120), the user merely provides a control command to the operation processing unit 160 to make the image displaying unit 120 display a target constellation list. Thereby, the user can select a target constellation from the plurality of target constellations of the target constellation list, S630. At this time, the operation processing unit 160 determines whether the target constellation selected by the user is exact or not according the longitude and latitude information and the satellite time (meaning that the target constellation can be observed in the current sky area), S640.

If the selected target constellation cannot be observed in the current sky area, the capturing apparatus inquires whether the user wants to select another target constellation, S650. If the selected target constellation can be observed in the current sky area and a specific mark shown on the location of the constellation photo corresponds to the selected target constellation, the user can determine whether the sky area displayed on the image displaying unit 120 is the same as the constellation photo with the specific mark or not, meaning if the target constellation is on the displayed image or not, S634.

When the target constellation is not on the displayed image, the user can adjust the focusing direction of the capturing apparatus according to the azimuth guidance provided from the azimuth guiding unit 170 and the constellation location on the constellation photo, or via the orientation constellation until the target constellation is found, S636.

Finally, when the user finds the target constellation (this means that the target constellation is displayed on the image captured by the capturing apparatus), the user can determine whether to capture the sky area displayed on the capturing image or not according to their desire, S640. When the user wants to capture the found target constellation, the user adjusts the camera shutter time of the capturing apparatus and other settings, such as focus distance, to capture the target constellation, S642. After the target constellation is captured, the user determines whether to continue finding other target constellations according to his or her requirements, S650.

When the user does not want to search for other target constellations, the method returns to the functions menu to escape from the star observing option or to execute other functional options, S660. When the user continues to search for other target constellations, S630 is repeated.

In the two star observing methods utilizing the capturing apparatus with a star observing function described above, the orientation constellation list and the target constellation list can be implemented via a main menu and an attached menu, for example the Summer Big Triangle includes Altair, Vega and Deneb. Furthermore, after the star observing function is started, the user can input the season and the time manually.

Because the capturing apparatus has a constellation database, the user can directly get the constellation photo to observe the target constellation manually.

A advantage of the present invention is that the user can utilize the capturing apparatus with the constellation database, the azimuth guiding unit, and the global position system to observe the stars.

Another advantage of the present invention is that the user can utilize the azimuth guidance provided from the azimuth guiding unit and the constellation photo in the constellation database to change the focusing direction of the capturing apparatus.

A further advantage of the present invention is that the capturing apparatus provides the corresponding orientation constellation list and the corresponding target constellation list according to the longitude and latitude information and the satellite time at which the user is using the capturing apparatus.

A further advantage of the present invention is that the azimuth guiding unit can provide the guiding label to the user according to the global position system, the constellation database, and the detection obtained from itself.

A further advantage of the present invention is that the guiding label provided by the azimuth guiding unit can be text, symbols, or figures.

A further advantage of the present invention is that the constellation database is located in the external memory, or is embedded in the internal memory unit of the capturing apparatus.

A further advantage of the present invention is that the capturing apparatus can cooperate with a specific lens to capture the target constellation.

A further advantage of the present invention is that the user can easily find a selected orientation constellation or the target constellation according to a specific mark shown on the constellation photo and the relative location between the selected orientation constellation and the target constellation.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A capturing apparatus with a star observing function, comprising:
an image capturing unit for capturing an image source, wherein the image source is processed by an image processing unit to form an image file;
a global position system for automatically downloading a longitude and latitude information and a satellite time according to the capturing location and time;
a constellation database for providing a plurality of constellation photos, wherein each constellation photo corresponds to the capturing location and time;
an operation processing unit for controlling operations of all components in the capturing apparatus, wherein the operation processing unit is used for processing the image source to generate the image file, and obtains a constellation photo from the constellation database that corresponds to the capturing location and time according to a user's setting;
an image displaying unit for displaying the image file and displaying the obtained constellation photo according to the user's setting, thereby, the user observe stars according to the capturing location and time and the constellation photo; and
a storing unit for storing the image file, the longitude and latitude information, and the satellite time.

2. The capturing apparatus with a star observing function as claimed in claim 1, wherein the storing unit is an internal memory unit, or an external memory.

3. The capturing apparatus with a star observing function as claimed in claim 2, wherein the constellation database is embedded in the capturing apparatus, the internal memory unit, or the external memory.

4. The capturing apparatus with a star observing function as claimed in claim 1, further comprising an azimuth guiding unit for automatically detecting an azimuth, thereby the user finds the constellation according to a azimuth guidance of the azimuth guiding unit.

5. The capturing apparatus with a star observing function as claimed in claim 4, wherein the azimuth guiding unit is a compass, or includes a compass.

6. The capturing apparatus with a star observing function as claimed in claim 4, wherein the azimuth guiding unit displays at least one guiding label on the image displaying unit so that the user changes a focusing direction of the capturing apparatus according to the guiding label to find the target constellation.

7. The capturing apparatus with a star observing function as claimed in claim 4, wherein the azimuth guiding unit is embedded in the capturing apparatus, or is externally connected with the capturing apparatus.

8. The capturing apparatus with a star observing function as claimed in claim 4, wherein the azimuth guiding unit provides a guiding label, and the guiding label is text, a symbol, or a figure.

9. The capturing apparatus with a star observing function as claimed in claim 1, wherein the image displaying unit is a touch panel.

10. The capturing apparatus with a star observing function as claimed in claim 1, wherein the storing unit stores an orientation constellation list or a target constellation list that is displayed on the image displaying unit for being selected by the user.

11. A star observing method utilizing the capturing apparatus with a star observing function, comprising:
showing a functions menu;
selecting a star observing function from the functions menu;
determining a location and a time of the capturing apparatus; and
showing a constellation photo and displaying the constellation photo.

12. The star observing method utilizing the capturing apparatus with a star observing function as claimed in claim 11, wherein the time is a season and a time inputted from a user manually.

13. A star observing method utilizing the capturing apparatus with a star observing function, comprising:
showing a functions menu;
selecting a star observing function from the functions menu;
showing an orientation constellation list and a constellation photo;
selecting an orientation constellation;
providing an azimuth guidance corresponding to the orientation constellation according to the orientation constellation and a focusing direction of the capturing apparatus;
adjusting the focusing direction to search the orientation constellation;
showing a target constellation list;
selecting a target constellation;
providing an azimuth guidance corresponding to the target constellation; and
finding the target constellation.

14. The star observing method utilizing the capturing apparatus with a star observing function as claimed in claim 13, further comprising a step of determining a location and a time of the capturing apparatus, and providing the orientation constellation list according to the location and the time of the capturing apparatus.

15. The star observing method utilizing the capturing apparatus with a star observing function as claimed in claim 14, wherein the step of determining a location and a time of the capturing apparatus is before the step of selecting a star observing function.

16. The star observing method utilizing the capturing apparatus with a star observing function as claimed in claim 14, wherein after the step of selecting a star observing function is executed, a time of the capturing apparatus is determined and the time is a season and a time inputted from a user manually.

17. The star observing method utilizing the capturing apparatus with a star observing function as claimed in claim 13, wherein the target constellation and the orientation constellation are searched by utilizing the azimuth guidance that corresponds to the target constellation and the orientation constellation individually.

18. The star observing method utilizing the capturing apparatus with a star observing function as claimed in claim 17, wherein the azimuth guidance are implemented by displaying a guiding label for guiding the focusing direction.

19. The star observing method utilizing the capturing apparatus with a star observing function as claimed in claim 13, wherein after the focusing direction is adjusted, the target constellation is found.

20. The star observing method utilizing the capturing apparatus with a star observing function as claimed in claim 19, wherein the step of adjusting the focusing direction comprises adjusting the focusing direction according to the constellation photo and the azimuth guidance that corresponds to the target constellation.
